(19) United States
(12) Patent Application Publication
(10) Pub. No.: US 2009/0274929 A1
(43) Pub. Date: Nov. 5, 2009

(54) Surface treated stainless steel sheet for automobile fuel tank excellent in corrosion resistance under salt corrosive environment

(76) Inventors: Shunji Sakamoto, Fukuoka (JP); Toshio Tanoue, Tokyo (JP); Naoto Ono, Tokyo (JP); Takao Kanai, Chiba (JP)

Correspondence Address: KENYON & KENYON LLP, ONE BROADWAY, NEW YORK, NY, 10004, US

(21) Appl. No.: 11/794,653

(22) PCT Filed: Jan. 5, 2007
(86) PCT No.: PCT/JP07/50362

§ 371 Date: Jul. 2, 2007

(30) Foreign Application Priority Data
Jan. 23, 2006 (JP) 2006-013345

(51) Int. Cl. B32B 15/01; B32B 15/04

(52) U.S. Cl. 428/681

(57) ABSTRACT

The present invention provides a surface treated stainless steel sheet for an automobile fuel tank excellent in corrosion resistance under a salt corrosive environment, that is, a surface treated stainless steel sheet for an automobile fuel tank excellent in corrosion resistance under a salt corrosive environment characterized by comprising a ferritic stainless steel sheet base material containing, by mass %, Cr: 10.0 to 25.0%, having an average r value of 1.4 or more, and having a total elongation of 30% or more or an austenitic stainless steel sheet base material containing Cr: 10.0 to 25.0%, having a total elongation of 45% or more, and having a work hardening rate of 400 N/mm² on the surface of which is formed a plating layer containing 5 to 13% of Si and having a balance of unavoidable impurities and Al by a weight of 5 g/m² to 80 g/m², between the plating layer and base iron is formed an alloy layer having a thickness of less than 5.0 μm, and on the plating layer of which is provided a lubricating film comprised of a soluble resin and, by mass %, 1 to 30% of a lubrication function imparting agent with respect to the soluble resin and having a friction coefficient of 0.15 or less.

### TECHNICAL FIELD

The present invention relates to surface treated stainless steel sheet for a fuel tank excellent in corrosion resistance in a salt corrosive environment and to a fuel tank.

### BACKGROUND ART

From the recent need to protect the environment and reduce the cost of lifecycles, fuel tanks, fuel pipes, and other fuel system parts are also being required to offer the characteristics of prevention of fuel evaporation emission and longer life.

Fuel tanks or fuel pipes of automobiles are required under American law to last for a guaranteed long life of 15 years or 150,000 miles. Fuel system parts satisfying this are currently being developed in three areas: plated steel, plastic, and stainless steel.

Among the three materials of plated steel, plastic, and stainless steel, plastic has a problem in recyclability, while plated steel has a concern over durability with respect to biofuels—which may very well spread in use in the future. On the other hand, stainless steel has the advantages of recycling as a iron base material and sufficient corrosion resistance to biofuels and is already being practically used as a material for fuel pipes.

However, stainless steel has the shortcoming that at the present time it is evaluated as not necessarily sufficient in corrosion resistance in a salt corrosive environment. That is, in accelerated laboratory tests simulating exposure to deicing salt, there is the problem that with SUS436L or other ferritic stainless steel, crevice corrosion occurs at the crevice structural parts or welded structural parts, while with SUS304L or other austenitic stainless steel, stress corrosion cracking occurs at the weld zones etc.

To solve this problem, several corrosion prevention technologies have been developed. For example, Japanese Patent Publication (A) No. 2003-277992 discloses a corrosion prevention method comprising applying a cationic electrodeposition coating to the surface of a fuel tank formed from a ferritic stainless steel sheet as a material, applying a zinc rich coating just to the weld zones, or using a steel sheet comprised of a steel sheet material formed with an Al plating layer, Zn plating layer, or a plating layer comprised of an alloy of Zn and one or more types of elements from Fe, Ni, Co, Mg, Cr, Sn, and Al.

Further, Japanese Patent Publication (A) No. 2004-115911 proposes a fuel tank formed from stainless steel sheet as a material and coated with a Zn-containing coating with a Zn content of 70% or less, while Japanese Patent Publication (A) No. 2003-221660 proposes a fuel tank formed from ferritic or austenitic stainless steel sheet having specific material properties given a hot dip aluminum plating as a material.

However, cationic electrodeposition coating is a method of dipping a coated object in a coating solution for electrodeposition and is actually being used for fuel pipes, but leaving aside small objects such as fuel pipes, application is difficult for objects such as fuel tanks with a large buoyancy. Further, there is also the problem that a sufficient corrosion prevention effect cannot be obtained for crevices of a shape with a small crevice opening and large depth.

Further, a zinc rich paint can suppress corrosion inside crevices by a cathode corrosion prevention effect, but this type of Zn-containing coating contains a large amount of Zn and has a relatively small amount of resin component, so is inferior in film adhesion compared with a general coating. In particular, in a severe salt corrosion test, the film blisters. In extreme cases, the problem sometimes arises that the film peels off. If trying to improve the film adhesion, one means is to reduce the Zn content, but if doing this, there is the problem that the inherently desired cathode corrosion prevention effect ends up being greatly impaired.

On the other hand, when using aluminum plated stainless steel sheet as a material, there is the problem that the plating layer peels off at the stage of formation into the fuel tank or fuel pipe. A plating layer meant for long term rust prevention usually contains as main components Al or Zn, which can exhibit a sacrificial corrosion prevention effect. Due to the need to improve the weight of plating, in general hot dipping is used, but the alloy layer formed at the time of hot dipping is fragile, so there is the problem that when subjected to severe plastic working such as when press forming it into a tank, the alloy layer cracks and the plating layer starts to peel off from this so a sufficient rust prevention effect can no longer be obtained. Further, the fragility of the alloy layer is also a problem leading to cracking during press forming.

### DISCLOSURE OF THE INVENTION

The present invention has as its object the provision of a stainless steel sheet material for an automobile fuel tank superior in corrosion resistance under a salt corrosive environment.

The inventors ran salt corrosion tests on various types of stainless steel and as a result concluded that to solve the problem of local corrosion at crevice structural parts introduced due to fastening or welding of attachments at the fuel tank or at the heat affected zone due to welding or brazing, cathodic corrosion prevention using a sacrificial anode is judged essential and that the most practical means is to use hot dip aluminum plated stainless steel.

The Al forming the main component of the plating layer is a metal element exhibiting a cathodic corrosion prevention effect on a material in a salt corrosive environment and has the advantage of a longer wear life compared with Zn which exhibits a similar effect. It can be evaluated as the most useful plating metal for the long term rust prevention of the object of the present invention. Further, as a plating method, hot dipping, which enables the weight of coating required for long term rust prevention to be secured, can be evaluated as having the great advantage of improving practical applicability in terms of already being industrially established. Further, the alloy layer inevitably formed by hot dipping, unlike the case of where the base material is steel, is known to exhibit a sacrificial corrosion prevention effect with respect to a stainless steel base material. The point that in addition to the simple corrosion prevention effect of the plating layer, the presence of the alloy layer ensures a sacrificial corrosion prevention effect even after the plating layer disappears has been evaluated as an advantage. However, the alloy layer formed between the aluminum plating layer and the stainless base material is fragile, so if the plated steel is plastically worked, plating peeling ends up occurring starting from cracks formed in the alloy layer and a sufficient rust prevention can no longer be obtained.

The inventors investigated the phenomenon of plating peeling and as a result learned that the plurality of cracks formed in an alloy layer connect and join inside the alloy layer, at the interface of the alloy layer and base iron, or at the interface of the alloy layer and plating layer and leads to plating peeling. This problem arising due to the fragility of the alloy layer has in the past been avoided by reducing the alloy layer thickness, but the conditions of the press forming of the fuel tank are extremely severe. The inventors learned that the problem cannot be solved by just greatly reducing the alloy layer thickness.

Therefore, the inventors engaged in research to discover means for solution other than factors in the alloy layer itself and as a result clarified that the occurrence and growth of cracks are governed by the stress applied to the alloy layer, discovered that it is crucial to maintain the frictional force at the boundary between the tool and worked material constantly at a low level while plastic working is being applied, and came up with the idea of forming a lubricating film over the plating layer as the most effective and realistic means for reducing the friction coefficient at the time of plastic working. The inventors engaged in various studies and as a result clarified the requirements of a lubricating film suitable for aluminum plated stainless steel and discovered that use of a lubricating film satisfying this requirement enables the plating peeling problem to be solved for the first time.

However, with a lubricating film just with a sufficiently low friction coefficient, a satisfactory corrosion resistance could not necessarily be obtained and a problem of work efficiency arose in the welding or brazing process after the press forming. That is, if a lubricating film remains at the tank shell in the welding or brazing process, the lubricating film breaks down by the heat resulting in the generation of fumes degrading the work environment. Not only that, carburization occurs at the surface layer of the steel sheet resulting in grain boundary corrosion. To solve this problem, the film has to be removed before the welding or brazing process after press forming. This removal work has to be easily achieved by a relatively simple technique. As opposed to this, the inventors studied the removability of the lubricating film and selected a composition of a lubricating film able to be removed by the easy technique of a warm water spray.

On the other hand, the inventors discovered in the process of studying the ease of removal of the lubricating film before welding or brazing process that the removability of the film also depends on the adhesion of the film with respect to the base layer. If stressing the lubrication function at the time of press forming, the adhesion of the lubricating film is important. To improve this, the usual practice is to apply chromate treatment or other chemical conversion. However, the inventors learned that by applying chromate treatment, hydrogen bonds form between the film and chromate and complete removal of film by a warm water spray becomes difficult. Therefore, they decided to directly form the lubricating film on the plating layer and decided to select a lubricating film composition enabling sufficient adhesion to be secured even without chemical conversion.

Further, an alloy layer is harmful not only in just causing plating layer peeling and degrading the rust prevention, but also in leading to cracking of the base material itself upon press forming under severe conditions and making press forming itself impossible. For this reason, the inventors determined the material quality conditions of the base material required from the viewpoint of cracking resistance and discovered that by, in addition to this, superposing the elements of reduction of the thickness of the above-mentioned alloy layer and formation of a soluble lubricating film, a fuel tank having a satisfactory rust prevention is obtained for the first time.

The present invention was made based on the above discoveries and has as its gist the following:

(1) A surface treated stainless steel sheet for an automobile fuel tank excellent in corrosion resistance under a salt corrosive environment characterized by comprising a ferritic stainless steel sheet base material containing, by mass %, Cr: 10.0 to 25.0%, having an average r value of 1.4 or more, and having a total elongation of 30% or more or an austenitic stainless steel sheet base material containing Cr: 10.0 to 25.0%, having a total elongation of 45% or more, and having a work hardening rate of 400 N/mm² on the surface of which is formed a plating layer containing 5 to 13% of Si and having a balance of unavoidable impurities and Al by a weight of 5 g/m² to 80 g/m², between the plating layer and base iron of which is formed an alloy layer having a thickness of less than 5.0 μm, and on the plating layer of which is provided a lubricating film comprised of a soluble resin and, by mass %, 1 to 30% of a lubrication function imparting agent with respect to the soluble resin and having a friction coefficient of 0.15 or less.

(2) A surface treated stainless steel sheet for an automobile fuel tank excellent in corrosion resistance under a salt corrosive environment as set forth in (1), characterized in that the lubricating film is comprised of a soluble resin, by mass %, 1 to 30% of a lubrication function imparting agent with respect to the soluble resin, and, by mass %, 30% or less of silica particles with respect to the soluble resin.

(3) A surface treated stainless steel sheet for an automobile fuel tank excellent in corrosion resistance under a salt corrosive environment as set forth in (1) or (2) characterized in that the soluble resin in the lubricating film is a soluble polyurethane water-soluble composition containing a carboxyl group or sulfonic acid group in the molecule.

(4) A surface treated stainless steel sheet for an automobile fuel tank excellent in corrosion resistance under a salt corrosive environment as set forth in any one of (1) to (3) characterized in that the lubricant in the lubricating film is comprised of one or more of a polyolefin wax, a fluorine-based wax, a paraffin-based wax, and a stearic acid-based wax.

(5) A surface treated stainless steel sheet for an automobile fuel tank excellent in corrosion resistance under a salt corrosive environment as set forth in any one of (1) to (4) characterized in that the thickness of the lubricating film is 0.5 to 5.0 μm in range.

### BRIEF DESCRIPTION OF THE DRAWINGS

FIG. 1 is a view showing the shape of a tank used for a press forming test.

FIG. 2 is a view showing the shape of a cut sample of a seam welded crevice structural part used for a corrosion test.

### BEST MODE FOR CARRYING OUT THE INVENTION

Below, the present invention will be described in detail.

The material for fuel system parts in the present invention is made a ferritic or austenitic stainless steel sheet containing Cr: 10.0 to 25.0%. Cr is the main element governing the corrosion resistance of a material. If less than 10.0%, the corrosion resistance becomes insufficient. The steel sheet is plated with aluminum as explained later and formed with an alloy layer, but this alloy layer is fragile and easily cracks, so sometimes both the alloy layer and steel sheet base iron are exposed to a corrosive environment. For example, if exposed to a salt corrosive environment over a long period, the plating layer becomes completely consumed and the alloy layer becomes exposed. The alloy layer at this time includes cracks reaching the base iron. Even in this state, if the base iron becomes more electrochemically precious than the alloy layer, the alloy layer will be selectively corroded and the base iron will be prevented from corroding.

The lower limit of the Cr content of the base iron for satisfying this electrochemical condition is 10.0%. On the other hand, Cr is a solid solution strengthening element. If included over 25.0%, the ductility of the material deteriorates and a sufficient formability can no longer be obtained. For this reason, the Cr content of the material is limited to 10.0 to 25.0%. Alloy elements other than Cr, for example, Ni, Mo, Cu, Ti, Nb, etc., may be suitably included in accordance with the known technology. However, even when including these elements, the amount of Cr must satisfy the above range.

The steel sheet containing Cr is plated by hot dip aluminum plating. Al gives a cathode corrosion prevention effect on the base material in a salt corrosive environment, so is deemed the main component in the plating metal. However, in a plating composition of Al alone, the alloy layer grows and plating peeling is induced, so a suitable amount of Si is included. To suppress the growth of the alloy layer, the suitable amount of Si is 5 to 13%, preferably 8 to 11%.

As the deposition of the plating layer, 5 to 80 g/m² is a suitable range. If the deposition is too small, a satisfactory rust prevention is not obtained, while if the deposition is too great, the alloy layer thickness increases and plating peeling is caused while conversely the rust prevention ability is degraded. Note that the plating weight defined here is the deposition on one side. It is defined as the amount found by dipping a sample of a plated sheet with a measured surface masked by sealing tape into a 10% NaOH solution so as to dissolve only the plating layer at the opposite surface to the measured surface, then peeling off the sealing tape and measuring the weight, then again dipping the sample in a 10% NaOH solution to dissolve the plating layer of the measured surface, then again measuring the weight and finding the change in these weights.

The alloy layer unavoidably formed at the time of hot dipping is poor in ductility and cracks due to working starting from plating peeling. To suppress this as much as possible, the alloy layer thickness has to be kept as small as possible. In the present invention, a thickness of 5.0 μm or less is made a necessary condition. Note that the alloy layer thickness spoken of here is defined as the average value of the measured values obtained by observation of any 10 fields in a cross-section of a plated sheet by an optical microscope at a power of 500.

The aluminum plated stainless steel sheet is formed with a lubricating film with a friction coefficient of 0.15 or less. If the friction coefficient exceeds 0.15, the lubrication characteristic is insufficient, so plating layer peeling starting from cracking of the alloy layer occurs, so a satisfactory corrosion resistance cannot be obtained.

As the composition of the lubricating film, it is necessary that, of course, the predetermined friction coefficient be obtained, and also that the resin component dissolve in warm water or alkali water to enable easy removal at a stage after press forming or other cold working and before welding or brazing. An organic lubricating film is liable to break down due to the rising heat of the welding or brazing resulting in carburization of the heat affected zone, a rise in the grain boundary corrosion sensitivity, and degradation of the long term corrosion resistance. Further, the decomposed products of the film due to the rising heat form fumes which cause a bad odor, therefore the welding or brazing work environment has to be kept clean. To solve this problem, it is sufficient to remove the lubricating film before the welding or brazing. It is necessary that the lubricating film can be removed by a simple means of an extent of cleaning using warm water or alkali water after press forming.

Such a soluble lubricating film may be obtained by using as the resin component one selected from a polyethylene glycol-based, polypropylene glycol-based, polyvinyl alcohol-based, acryl-based, polyester-based, polyurethane-based, or other resin aqueous dispersion or water soluble resin, but as a soluble resin component matching with the object of securing a high formability or adhesion, a soluble polyurethane water-soluble composition containing a carboxyl group or sulfonic acid group in the molecule is most effective. The soluble polyurethane water-soluble composition is obtained by reacting a compound having at least two isocyanate groups per molecule, a compound having at least two hydroxy groups per molecule, and a compound having at least one hydroxy group or other active hydrogen group in the molecule and containing a carboxyl group, sulfonic acid group, or other acid group and dissolving or dispersing in water.

As the compound having at least two isocyanate groups per molecule, tetramethylene diisocyanate or 1,2-butylene diisocyanate or other aliphatic diisocyanates, 1,3-cyclopentane diisocyanate or 3-isocyanate methyl-3,5,5-trimethylcyclohexyl isocyanate or other alicyclic diisocyanates, p-phenylene diisocyanate or 1,5-napthalene diisocyanate or other aromatic diisocyanates, 1,3-xylene diisocyanate or 1,3-bis(1-isocyanate-1-methylethyl)benzene or other aromatic aliphatic diisocyanates etc. may be used.

As a compound having at least two hydroxyl groups per molecule, a polyester polyol, polyether polyol, polyether ester polyol, polyester amide polyol, acryl polyol, polycarbonate polyol, etc. may be used. The molecular weight of these compounds is preferably 200 to 10,000 from the viewpoint of the film strength or other performance, the reaction rate with isocyanate groups, production efficiency, and other points. Further, for optimization of the film properties, diethylene glycol, triethylene glycol, or other glycols may be mixed in for the purpose of adjusting the urethane bond concentration.

As a compound having at least one hydroxy group or other active hydrogen group in its molecule and containing a carboxyl group, sulfonic acid group, or other acid group, a phenol sulfonic acid, sulfobenzoic acid, or other sulfone group-containing compound, adipic acid, dimethylol propionic acid, or other carboxyl group-containing compound, and their derivatives or polyester polyols obtained by copolymerization of these may be used. To dissolve or disperse a soluble polyurethane water-soluble composition in water, the carboxyl groups and sulfonic acid groups may be neutralized. As the neutralization agent, sodium hydroxide or another alkali metal hydroxide or an amine may be used. As the method of addition, it may be directly added to the polyurethane prepolymer or may be added to the water when dissolving or dispersing the polyurethane prepolymer.

As the lubrication function imparting agent in the soluble lubricating film using the soluble polyurethane water-soluble composition as a binder component, one comprised of one or more types of agents from a polyolefin-based wax, fluororesin-based wax, paraffin-based wax, and stearic acid-based wax may be used. These wax resins may be used as particles whose average particle size is preferably 10 μm or less. If the particle size is large, the continuity or uniformity of the film is impaired and a stable lubrication effect is difficult to obtain. Further, the content of these wax components in the film is preferably 1 to 30 mass % in range with respect to the solid content of the soluble polyurethane water-soluble composition. If less than 1%, the predetermined lubrication effect is not obtained, while if over 30%, the film strength drops and galling occurs.

Further, the soluble lubricating film may also contain a third component comprised of silica particles. Silica particles are useful for improving film strength and suppressing galling etc. As the silica particles, water dispersed colloidal silica etc. may be used. The particle size is preferably a primary particle size of 2 to 30 nm and a secondary particle size of 100 nm or less. A content with respect to the solid content of the soluble polyurethane water-soluble composition is preferably 30 mass % or less. This is because if included in a large amount, the stretch of the film drops, so conversely galling more easily occurs.

Next, regarding the thickness of the lubricating film, if too thin, the lubrication effect becomes insufficient, so a certain extent of thickness is necessary. Use of 0.5 μm as the required lower limit film thickness in control is preferable. Regarding the upper limit, in the case of an insoluble lubricating film which cannot be removed after press forming or other cold forming and before a welding or brazing process, remainder of the lubricating film becomes a major cause behind deterioration of the weldability or brazeability, so the thickness should be limited. 5 μm is preferably made the upper limit of film thickness. On the other hand, in the case of a soluble lubricating film able to be removed before welding or brazing, if too thick, time is taken for film removal, degradation of the alkali solution used is accelerated, and there are other detrimental effects on the film removal process, so 5 μm is preferably made the upper limit.

The above-mentioned lubricating film is one directly formed on the plating layer. A lubricating film comprised of a soluble resin of the above-mentioned composition has sufficient adhesion with respect to a plating layer, so measures for improvement of adhesion by chromate treatment or other chemical conversion are unnecessary. Not only this, but rather application of chemical conversion results in hydrogen bonds formed between the lubricating film and chemical conversion film making complete removal of the lubricating film difficult. The means for forming the lubricating film is not particularly limited, but roll coating is preferable from the viewpoint of uniform control of the film thickness.

Regarding the material quality characteristics of the base material of the aluminum plated stainless steel sheet, from the viewpoint of the press formability, when the base material is ferritic stainless steel, the two requirements are that the average r value be 1.4 or more and the total elongation be 30% or more, while when the base material is austenitic stainless steel, the two requirements are that the total elongation be 45% or more and the work hardening rate be 400 N/mm² or less. Both the two requirements have to be satisfied. This is because with steel sheet where even one of these requirements is not satisfied, even if a lubricating film is formed, the alloy layer cracks or the steel sheet itself cracks at the locations where plating peeling occurs and a fuel tank can no longer be formed.

Note that the material quality characteristics are found by a tensile test using a No. 13B test piece defined in JIS Z2201. The total elongation is found from the amount of change between standard points before and after the tensile test. The average r value is defined as (r_{L}+r_{C}+2r_{D})/4. r_{L}, r_{C}, and r_{D} are Lankford values in a rolling direction, a direction perpendicular to the rolling direction, and a direction 45 degrees with respect to the rolling direction. The work hardening rate is found by measuring the stresses when applying tensile strain of 30% and 40% and calculating the gradient between them.

However, when the material quality characteristics are satisfied, if the above-mentioned lubricating film is not formed, it is not possible to overcome the problem of plating layer peeling starting from the alloy layer cracking. Not only that, the formability into a fuel tank or fuel pipe itself becomes difficult. As the means to solve these problems, the presence of a lubricating film suitable for the above-mentioned aluminum plated stainless becomes essential.

The aluminum plated stainless steel lubricated steel sheet material satisfying the above requirements is formed into a fuel tank by press forming, seam welding, spot welding, projection welding, or other such welding or brazing, attachment of metal fittings, and other usual forming and assembly processes. However, at the stage after the end of press forming and before welding or brazing, a step of removing the lubricating film using warm water or alkali water is included.

The formed fuel tank is sometimes visible from the outside in the state mounted in a vehicle depending on the model, so should be painted black from the viewpoint of aesthetic design. Further, welding or brazing causes the aluminum plating to evaporate and the plating layer to be damaged, so the tank may be partially touched up at those locations for the purpose of making the corrosion resistance more reliable. As the coating method, the spray method or another existing method is sufficient.

### EXAMPLES

The present invention will be explained in further detail based on examples.

Slabs of ferritic stainless steel A, austenitic stainless steel B, and comparative steel C of the compositions shown in Table 1 were processed by hot rolling-annealing of the hot rolled sheet-pickling-first cold rolling-process annealing-second cold rolling-final annealing to produce 0.8 mm thick steel sheets. The hot rolled sheets were annealed changed from 900 to 1000° C. in range, the cold rolling reduction rates were changed to a cumulative 70 to 85% in range, and the process annealing and final annealing were changed from 750 to 1000° C. in range to change the material quality characteristics. Test pieces were taken from these steel sheets and subjected to tensile tests to obtain a grasp of the material quality characteristics shown in Table 2.

TABLE 1

| | | Chemical ingredients (mass %) | | | | | | | | | |
|---|---|---|---|---|---|---|---|---|---|---|---|
| Code | Class | C | Si | Mn | P | S | Cu | Cr | Ni | Mo | Ti |
| A | Ferritic | 0.0051 | 0.05 | 0.05 | 0.015 | 0.0011 | 0.01 | 17.16 | 0.01 | 1.19 | 0.203 |
| B | Ferritic | 0.0049 | 0.46 | 0.34 | 0.019 | 0.0041 | 0.01 | 10.92 | 0.01 | 0.01 | 0.181 |
| C | Austenitic | 0.0215 | 0.38 | 0.87 | 0.016 | 0.0012 | 0.01 | 18.08 | 8.37 | 0.11 | — |
| D | Comparison | 0.0023 | 0.02 | 0.01 | 0.001 | 0.0005 | 0.01 | 8.85 | 0.01 | 0.01 | — |

Note)
Underlines indicate outside the present invention in range.

Each steel sheet was hot dip aluminum plated changed in weight by controlling the gas wiping conditions. The plating bath temperature was set at 660 to 720° C. The plating metal was made a mainly Al composition containing Si as an component other than the unavoidable impurities. The Si content, plating bath temperature, and plating deposition were changed to change the alloy layer thickness. A φ100 mm sample was punched out from this hot dip Al plated sheet and masked at its measured surface by sealing tape. The obtained plated sheet sample was dipped in a 10% NaOH solution to dissolve only the plating layer at the opposite side to the measured surface, then the sealing tape was peeled off. This was again punched out to φ70 mm. The obtained sample sheet was measured for weight, then was dipped in a 10% NaOH solution to dissolve the plating layer of the measured surface, then was measured for weight again. The plating weight at one side was found from the change of these weights. The alloy layer thickness was found by observation by an optical microscope of the cross-section of a plated sheet. The sample was observed for any 10 fields at a power of 500, the average value was found, and that was used as the alloy layer thickness.

The soluble lubricating film was formed on the aluminum plated steel sheet in the following way.

A four-neck flask equipped with a stirrer, Dimroth condenser, nitrogen introducing tube, silica gel drying tube, and thermometer was charged with 87.11 g of 3-isocyanate methyl-3,5,5-trimethyl cyclohexyl isocyanate, 31.88 g of 1,3-bis(1-isocyanate-1-methylethyl)benzene, 41.66 g of dimethylol propionic acid, 4.67 g of triethylene glycol, 62.17 g of a polyester polyol comprised of adipic acid, neopentyl glycol, and 1,6-hexane diol of a molecular weight of 2000, and 122.50 g of a solvent comprised of acetonitrile. The mixture was raised in temperature in a nitrogen atmosphere to 70° C. and stirred for 4 hours to obtain an acetonitrile solution of a polyurethane prepolymer. 346.71 g of this polyurethane prepolymer solution was dispersed in an aqueous solution of 12.32 g of sodium hydroxide dissolved in 639.12 g of water by a homodisperser to obtain an emulsion. To this was added a solution of 12.32 g of 2-[(2-aminoethyl)amino]ethanol diluted by 110.88 g of water to cause a chain elongation reaction, then the acetonitrile used at the time of synthesis of the polyurethane prepolymer was distilled off at 50° C. and 150 mmHg to obtain a polyurethane water-soluble composition not substantially containing any solvent, having an acid value of 69, having a solid content concentration of 25%, and having a viscosity of 30 mPa·s.

This polyurethane water-soluble composition was mixed with one or more components selected from a low density polyethylene wax with a softening point of 110° C. and an average particle size of 2.5 μm, a polytetrafluoroethylene wax with an average particle size of 3.5 μm, a synthetic paraffin wax with a melting point of 105° C. and an average particle size of 3.5 μm, a calcium stearate wax with an average particle size of 5.0 μm, and colloidal silica with a primary average particle size of 20 nm and a heated residue of 20% to obtain a coating. The ratio of the wax component blended in the polyurethane water-soluble composition was changed to change the friction coefficient of the lubricating film formed. This coating was applied to the aluminum plated steel sheet by roll coating and baked at a sheet temperature of 80° C. to form a soluble lubricating film. The film thickness was changed in various ways and measured by an infrared thickness meter. Further, for the insoluble lubricating film, the lubricating coating Paltop TD908® made by Nihon Parkerizing was applied by the roll coat method to the aluminum plated steel sheet.

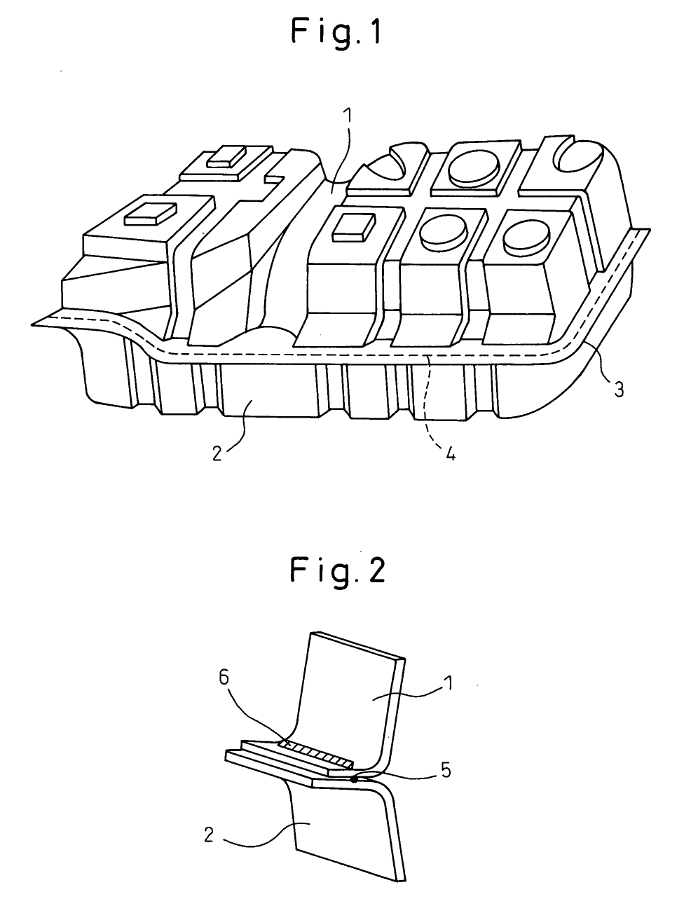

The thus produced lubricant-coated aluminum plated steel sheet was used for a press forming test. FIG. 1 is a view showing the shape of the tank used for a press forming test. The state where the upper shell 1 and lower shell 2 were separately press formed, then the two flange parts 3 were joined and given the seam weld 4 shown by the broken line part is shown. An actual tank then has a pump retainer, valve retainer, fuel pipe, and other parts joined to it by welding or brazing to be finished, but FIG. 1 shows the state one step before this final shape.

Both the upper shell 1 and the lower shell 2 were formed with dent for improving the rigidity of the tank, dent for attaching the tank hanging bands, projections at parts for contacting the chassis, etc. at different locations. The heights of formation were made about 150 mm for both shells. The upper sheet is more complicated in shape than the lower shell and more severe in forming conditions. Further, in some comparative examples, a press forming test was conducted using a steel sheet of a material not formed with a lubricating film. In this case, press oil was coated for the test.

Both the upper and lower pressed parts after this press forming test were evaluated for base material cracking and plating peeling. For parts where base material cracking occurred, the subsequent tests were suspended. For cases where no cracking was observed, the lubricating film was removed by a 50° C. warm water spray. Whether or not any lubricating film remained was evaluated by the two methods of the method of obtaining samples from parts of the two pressed upper and lower parts, obtaining spectra by the infrared spectroscopy, and measuring the absorbances of the C—H absorptions and the method of spraying the entire upper and lower shells by an acetone solution containing Methyl Violet as an indicator and observing any dyeing. Cases where remaining film was suggested by either method were evaluated as “Fail”, while cases where remaining film was not found by either method was evaluated as “Pass”. After this, the flange part formed by joining the two upper and lower pressed parts was seam welded by the resistance welding method to obtain a tank shaped article. Note that for pressed parts where insoluble lubricating films were used, the process of removing the lubricating film by a warm water spray was omitted.

At the seam welded part of this tank shaped article, a welded crevice structure having a crevice opening of about 0.5 mm and a crevice depth of about 15 mm was formed at the outside of the tank. A cut sample shown in FIG. 2 was taken from the seam weld zone in a manner including the crevice structural part, the inner circumference side and end surfaces of the tank were sealed, then the result was used for a salt corrosion test. As the condition of the corrosion test, a 5% NaCl solution was sprayed, then a composite cycle test of 35° C.×2 Hr→forced drying 60° C.×4 Hr→wetting (relative humidity 90%) 50° C.×2 Hr was repeated for 60 cycles. After this, the seam welded crevice structural part was disassembled, the rust was removed, and the corrosion depth inside the crevice was measured by the microscope focal depth method.

FIG. 2 is a view showing the shape of a cut sample of a seam welded crevice structural part used for a corrosion test. Reference numeral 4 shown in the figure shows a seam weld nugget, while 6 shows a heat affected zone. Note that part of the test materials were treated by chromate after aluminum plating. The weight was made 20 mg/m². Further, parts of the test materials were seam welded to form tanks which were then spray coated (using coating comprised of Emalta 5600® made by Aisin Chemical, film thickness of 25 μm).

The test conditions and test results are shown in Table 2.

In No. 1 to 11 of the invention examples, press forming was possible without any cracking of the base material or plating peeling and the films could be removed after press forming. In addition, the crevice corrosion of ferritic steel and the stress corrosion cracking of austenitic steel which had become problems in the past in welded crevice structural part of a formed tank can be prevented and the satisfactory excellent corrosion resistance aimed at by the present invention can be achieved.

On the other hand, Comparative Example No. 12 has a content of the wax component in the lubricating film outside the requirements of the present invention, Comparative Example No. 13 has silica of a content outside the requirements of the present invention, Comparative Example Nos. 14, 15, 18 have one or two requirements of the alloy layer thickness or plating weight outside the conditions of the present invention, and Comparative Example Nos. 23, 24 has requirements of the plating composition and requirements of the alloy layer both outside the conditions of the present invention. For this reason, plating peeling occurs in press forming, so in the corrosion test, a satisfactory corrosion resistance cannot be exhibited. Further, Comparative Example No. 22 has steel component requirements outside the present invention in range, so a satisfactory corrosion resistance could not be obtained.

Comparative Example Nos. 16, 17, 21 have aluminum plated steel sheets with requirements of material quality outside the present invention in range, so cracking of the base material in press forming could not be prevented. Comparative Example No. 19 had too small a wax content in the lubricating film, so the predetermined friction coefficient of the requirement of the present invention is not obtained and cracks occur in press forming. Further, Comparative Example Nos. 25 and 26 had steel components, materials, platings, alloy layers, and lubricating film requirement in the present invention in range, but there was chromate treatment between the lubricating films and plating layers, so the lubricating film was incompletely removed after pressing. For this reason, grain boundary corrosion occurred and a satisfactory corrosion resistance could not be obtained.

Further, Comparative Example Nos. 27, 28 have lubricating films which are insoluble, so the films cannot be removed and a satisfactory corrosion resistance could not be obtained. Further, Comparative Example No. 20 confirms the problem of press forming when not forming a lubricating film, while Comparative Example Nos. 29, 30 confirm the problem of crevice corrosion of ferritic steel and stress corrosion cracking of austenitic steel when not performing aluminum plating.

TABLE 2

| | | | | Work | | | Alloy | | Lubricating film | | | | |
|---|---|---|---|---|---|---|---|---|---|---|---|---|---|
| | | Aver- | Total | hard. | Plating | Plating | layer | | | | | Silica | |
| | | ager | elong. | rate | compo- | depos. | thick. | Chromate | | Resin | Lubrication | cont. | Thick. |
| No | Steel | value | (%) | (N/mm²) | sition | (g/m²) | (μm) | treatment | Yes/no | ingredient | agent *1 | (%) | (μm) |
| 1 | A | 2.10 | 35.1 | — | Al—10%Si | 9 | 2.7 | None | Yes | Sol. poly- | PE wax 10% | — | 1.2 |
| 2 | A | 2.10 | 35.1 | — | Al—10%Si | 21 | 2.1 | None | Yes | urethane | PE wax 10% | 10 | 1.2 |
| 3 | A | 2.10 | 35.1 | — | Al—10%Si | 40 | 2.7 | None | Yes | | PE wax 10% | 10 | 1.1 |
| 4 | A | 2.03 | 34.9 | — | Al—6%Si | 15 | 3.3 | None | Yes | | PE wax 3% | — | 1.2 |
| 5 | A | 1.98 | 34.7 | — | Al—10%Si | 75 | 3.9 | None | Yes | | PE wax 25% | 3 | 1.2 |
| 6 | A | 2.00 | 35.0 | — | Al—6%Si | 8 | 3.8 | None | Yes | | PTFE wax 20% | — | 1.1 |
| 7 | A | 1.60 | 31.3 | — | Al—10%Si | 75 | 1.9 | None | Yes | | Paraffin | — | 1.1 |
| | | | | | | | | | | | wax 10% | | |
| 8 | A | 2.10 | 35.1 | — | Al—10%Si | 40 | 2.7 | None | Yes | | Calcium | — | 1.2 |
| | | | | | | | | | | | stearate | | |
| | | | | | | | | | | | wax 10% | | |
| 9 | B | 2.36 | 36.5 | — | Al—10%Si | 61 | 2.9 | None | Yes | | PE wax 10% | 10 | 1.2 |
| 10 | C | — | 50.5 | 367 | Al—10%Si | 20 | 2.1 | None | Yes | | PE wax 10% + | 5 | 1.5 |
| | | | | | | | | | | | PTFE wax 10% | | |
| 11 | C | — | 49.9 | 364 | Al—12%Si | 40 | 3.1 | None | Yes | | PE wax 20% | — | 1.2 |
| 12 | A | 2.19 | 35.1 | — | Al—10%Si | 9 | 2.7 | None | Yes | | PE wax 35% | 5 | 1.2 |
| 13 | A | 1.84 | 32.9 | — | Al—10%Si | 9 | 2.7 | None | Yes | | PE wax 10% | 35 | 1.2 |
| 14 | A | 2.01 | 34.9 | — | Al—10%Si | 88 | 5.1 | None | Yes | | PE wax 20% | — | 1.1 |
| 15 | A | 2.21 | 35.6 | — | Al—10%Si | 3 | 2.1 | None | Yes | | PE wax 5% | — | 1.1 |
| 16 | A | 1.36 | 33.1 | — | Al1310%Si | 40 | 2.9 | None | Yes | | PE wax 10% | — | 1.2 |
| 17 | A | 1.41 | 28.7 | — | Al—10%Si | 40 | 2.9 | None | Yes | | PE wax 10% | — | 1.2 |
| 18 | A | 1.85 | 33.0 | — | Al—6%Si | 58 | 5.2 | None | Yes | | PE wax 20% | — | 1.2 |
| 19 | A | 2.10 | 35.1 | — | Al—10%Si | 40 | 2.7 | None | Yes | | PE wax 0.8% | 20 | 1.1 |
| 20 | A | 2.10 | 35.1 | — | Al—10%Si | 40 | 2.7 | None | Yes | | | | |
| 21 | C | — | 50.1 | 412 | Al—10%Si | 8 | 3.1 | None | Yes | Sol. poly- | PE wax 10% | — | 1.2 |
| 22 | D | 1.51 | 31.2 | — | Al—10%Si | 40 | 3.2 | None | Yes | urethane | PE wax 20% | — | 1.2 |
| 23 | A | 1.95 | 32.1 | — | Al—4%Si | 60 | 6.7 | None | Yes | | PE wax 20% | — | 1.1 |
| 24 | B | 1.65 | 35.0 | — | Al—15%Si | 58 | 5.8 | None | Yes | | PE wax 20% | — | 1.1 |
| 25 | A | 2.10 | 35.1 | — | Al—10%Si | 9 | 2.7 | Yes | Yes | | PE wax 3% | — | 1.0 |
| 26 | A | 2.03 | 34.9 | — | Al—8%Si | 15 | 3.3 | Yes | Yes | | PE wax 3% | — | 1.0 |

| | | | | | | | | | | | |
|---|---|---|---|---|---|---|---|---|---|---|---|
| 27 | A | 2.10 | 35.1 | — | Al—10%Si | 9 | 2.7 | Yes | Yes | Insoluble TD906 | 1.0 |
| 28 | A | 2.10 | 35.1 | — | Al—10%Si | 9 | 2.7 | None | Yes | Insoluble TD906 | 1.0 |

| | | | | | | | | | | | | |
|---|---|---|---|---|---|---|---|---|---|---|---|---|
| 29 | A | 2.06 | 35.1 | — | No plating | — | None | Yes | Sol. poly- | PE wax 10% | — | 1.2 |
| 30 | C | — | 50.5 | 367 | No plating | — | None | Yes | urethane | PE wax 10% | — | 1.2 |

| | | | | | | Local | | | |
|---|---|---|---|---|---|---|---|---|---|
| | | | | | | corr. | SCC | | |
| | | Press test | | Removal | | inside | at | | |
| | Fric. | result *2 | | of lub. | Black | crevices | weld | Overall | |
| No | coef. | Lower | Upper | film | coating | *3 | zone | eval. | Remarks |
| 1 | 0.039 | Good | Good | Pass | None | Good | None | Good | Inv. |
| 2 | 0.094 | Good | Good | Pass | None | Good | None | Good | ex. |
| 3 | 0.082 | Good | Good | Pass | Yes | Good | None | Good | |
| 4 | 0.134 | Good | Good | Pass | Yes | Good | None | Good | |
| 5 | 0.038 | Good | Good | Pass | None | Good | None | Good | |
| 6 | 0.039 | Good | Good | Pass | None | Good | None | Good | |
| 7 | 0.075 | Good | Good | Pass | None | Good | None | Good | |
| 8 | 0.054 | Good | Good | Pass | None | Good | None | Good | |
| 9 | 0.111 | Good | Good | Pass | None | Good | None | Good | |
| 10 | 0.037 | Good | Good | Pass | None | Good | None | Good | |
| 11 | 0.055 | Good | Good | Pass | None | Good | None | Good | |
| 12 | 0.061 | Good | Poor | Pass | None | Poor | None | Poor | Comp. |
| 13 | 0.071 | Poor | V. poor | Pass | Film removability | | | Poor | ex. |
| | | | | | studied after press | | | | |
| | | | | | test, then stopped | | | | |
| 14 | 0.054 | Good | Poor | Pass | None | Poor | None | Poor | |
| 15 | 0.109 | Good | Good | Fail | None | Poor | None | Poor | |
| 16 | 0.056 | Poor | V. poor | Pass | Film removability | | | Poor | |
| 17 | 0.049 | Poor | V. poor | Pass | studied after press | | | Poor | |
| 18 | 0.051 | Poor | V. poor | Fail | test, then stopped | | | Poor | |
| 19 | 0.158 | Poor | Poor | Fail | None | Poor | None | Poor | |
| 20 | — | Poor | V. poor | Fail | Film removability | | | Poor | |
| 21 | 0.088 | Good | V. poor | Pass | studied after press | | | Poor | |
| | | | | | test, then stopped | | | | |
| 22 | 0.043 | Good | Good | Pass | None | Poor | None | Poor | |
| 23 | 0.052 | Good | Poor | Pass | None | Poor | None | Poor | |
| 24 | 0.052 | Good | Poor | Pass | None | Poor | None | Poor | |
| 25 | 0.979 | Good | Good | Fail | Yes | Poor | None | Poor | |
| 26 | 0.129 | Good | Good | Fail | Yes | Poor | None | Poor | |
| 27 | 0.085 | Good | Good | Fail | Yes | Poor | None | Poor | |
| 28 | 0.083 | Good | Poor | Fail | Yes | Poor | None | Poor | |
| 29 | 0.065 | Good | Good | Pass | Yes | Poor | None | Poor | |
| 30 | 0.059 | Good | Good | Pass | None | Poor | Yes | Poor | |

Note 1)
Underlines indicate outside the present invention in range
Note 2)
*1 PE wax: Low density polyethylene wax
PTFE wax: Polytetrafluoroethylene wax
Contents are ratios to resin solid content
*2 Good: No base material cracks, no plating peeling
Poor: No base material cracks, plating peeling
Very poor: Base material cracks, plating peeling
*3 Good: Ratio of max. corrosion depth to orig. thickness ≦50%
Poor: Ratio of max. corrosion depth to orig. thickness >50%

### INDUSTRIAL APPLICABILITY

According to the present invention, a stainless steel sheet for a material for a fuel tank excellent in corrosion resistance under a salt corrosive environment is obtained.

1. A surface treated stainless steel sheet for an automobile fuel tank excellent in corrosion resistance under a salt corrosive environment characterized by comprising a ferritic stainless steel sheet base material containing, by mass %, Cr: 10.0 to 25.0%, having an average r value of 1.4 or more, and having a total elongation of 30% or more or an austenitic stainless steel sheet base material containing Cr: 10.0 to 25.0%, having a total elongation of 45% or more, and having a work hardening rate of 400 N/mm² on the surface of which is formed a plating layer containing 5 to 13% of Si and having a balance of unavoidable impurities and Al by a weight of 5 g/m² to 80 g/m², between the plating layer and base iron of which is formed an alloy layer having a thickness of less than 5.0 μm, and on the plating layer of which is provided a lubricating film comprised of a soluble resin and, by mass %, 1 to 30% of a lubrication function imparting agent with respect to the soluble resin and having a friction coefficient of 0.15 or less.

2. A surface treated stainless steel sheet for an automobile fuel tank excellent in corrosion resistance under a salt corrosive environment as set forth in claim 1, characterized in that the lubricating film is comprised of a soluble resin, by mass %, 1 to 30% of a lubrication function imparting agent with respect to the soluble resin, and, by mass %, 30% or less of silica particles with respect to said soluble resin.

3. A surface treated stainless steel sheet for an automobile fuel tank excellent in corrosion resistance under a salt corrosive environment as set forth in claim 1 characterized in that the soluble resin in the lubricating film is a soluble polyurethane water-soluble composition containing a carboxyl group or sulfonic acid group in the molecule.

4. A surface treated stainless steel sheet for an automobile fuel tank excellent in corrosion resistance under a salt corrosive environment as set forth in claim 1 characterized in that the lubrication function imparting agent in the lubricating film is comprised of one or more of a polyolefin wax, a fluorine-based wax, a paraffin-based wax, and a stearic acid based wax.

5. A surface treated stainless steel sheet for an automobile fuel tank excellent in corrosion resistance under a salt corrosive environment as set forth in claim 1 characterized in that the thickness of the lubricating film is 0.5 to 5.0 μm in range.
